(19) United States
(12) Patent Application Publication
(10) Pub. No.: US 2016/0127581 A1
(43) Pub. Date: May 5, 2016

(54) COMMUNICATION SYSTEM, COMMUNICATION APPARATUS, METHOD OF CONTROLLING THE SAME, INFORMATION PROCESSING APPARATUS, METHOD OF CONTROLLING THE SAME AND STORAGE MEDIUM

(71) Applicant: CANON KABUSHIKI KAISHA, Tokyo (JP)

(72) Inventor: Ryousuke Suzuki, Kashiwa-shi (JP)

(21) Appl. No.: 14/923,675

(22) Filed: Oct. 27, 2015

(30) Foreign Application Priority Data
Nov. 4, 2014 (JP) 2014-224615

(51) Int. Cl. H04N 1/00; G06F 3/12; H04W 36/14

(52) U.S. Cl. CPC H04N 1/00307; H04W 36/14; G06F 3/1222; G06F 3/1236; G06F 3/1238; G06F 3/1292; H04W 88/06

(57) ABSTRACT

A technique for automatically activating an application corresponding to an operation that a user is attempting to perform in a communication apparatus when connecting to an information processing apparatus from the communication apparatus using a short-range wireless communication is provided. A mobile device connects to an image forming apparatus by NFC, obtains from the image forming apparatus by NFC communication connection information (handover information) for connecting to the image forming apparatus by WiFi, and performs a handover from NFC communication to WiFi communication. The mobile device receives from the image forming apparatus by WiFi communication information indicating a number of print jobs that the image forming apparatus holds, determines, based on the received information, an application to be activated from a plurality of applications that use WiFi communication after the handover, and activates the determined application.

### BACKGROUND OF THE INVENTION

1. Field of the Invention

The present invention relates to a communication system that uses a short-range wireless communication such as NFC®, a communication apparatus, a method of controlling the same, an information processing apparatus, a method of controlling the same, and a storage medium.

2. Description of the Related Art

A technique is known in which a print job that is input into a printing apparatus in advance is executed in the printing apparatus by performing authentication processing by reading authentication information in an IC card by a short-range wireless communication using a card reader arranged in the printing apparatus (refer to Japanese Patent Laid-Open No. 2006-99714). Also, a technique is known in which when a file is to be transmitted to a printing apparatus from a mobile device by a short-range wireless communication, a list of files is displayed on the mobile device, and the file to transmit is designated (refer to Japanese Patent Laid-Open No. 2006-020078). In Japanese Patent Laid-Open No. 2006-157392, a technique in which a communication apparatus is detected by a short-range wireless communication, an application program specified by a service code received from the communication apparatus is caused to be activated, and predetermined processing is caused to execute is proposed as a technique that uses such a short-range wireless communication.

As described above, it is possible to realize various operations in a mobile device such as a job execution instruction made to a printing apparatus by causing the mobile device (communication apparatus) to approach the printing apparatus (information processing apparatus) when using a short-range wireless communication such as NFC. For example, it is possible to realize an operation in a mobile device towards a printing apparatus using higher speed communication, by first connecting to the printing apparatus by a short-range wireless communication and then performing a handover to a communication by WiFi®.

However, there are cases in which when performing an operation towards a printing apparatus by connecting to the printing apparatus from a mobile device using a short-range wireless communication as described above, there exist a plurality of candidates as candidates for the operation that a user is attempting to perform. For example, there are operations for inputting new jobs into a printing apparatus from a mobile device, operations for causing a printing apparatus to execute a job that the printing apparatus already holds (that is already input into the printing apparatus), and the like. In such cases, a user must perform a desired operation by causing an application for realizing the operation that the user is attempting to perform, to be activated on the mobile device.

### SUMMARY OF THE INVENTION

The present invention was conceived in view of the above described issues. The present invention provides a technique for automatically activating an application corresponding to an operation that a user is attempting to perform in a communication apparatus when connecting to an information processing apparatus from the communication apparatus using a short-range wireless communication.

According to one aspect of the present invention, there is provided a communication system comprising an information processing apparatus capable of executing a job, and a communication apparatus capable of communicating with the information processing apparatus, wherein the information processing apparatus comprises: a first communication unit configured to perform a communication of a first communication scheme for a short-range wireless communication; and a second communication unit configured to perform a communication of a second communication scheme for a wireless communication that is of a higher speed than that of the first communication scheme, and wherein the communication apparatus comprises: an obtaining unit configured to connect to the information processing apparatus by the first communication scheme, and to obtain from the information processing apparatus by the communication of the first communication scheme connection information for connecting to the information processing apparatus by the second communication scheme; a connection unit configured to connect to the information processing apparatus by the second communication scheme based on the connection information obtained by the obtaining unit; and an activation unit configured to determine, in accordance with a number of jobs that the information processing apparatus holds, an application to be activated from a plurality of applications that use the communication of the second communication scheme by using information received from the information processing apparatus by communication of the first communication scheme or the second communication scheme, and to activate the determined application.

According to another aspect of the present invention, there is provided a communication apparatus capable of communicating with an information processing apparatus, the communication apparatus comprising: an obtaining unit configured to connect to the information processing apparatus by a first communication scheme for a short-range wireless communication, and to obtain from the information processing apparatus by a communication of the first communication scheme connection information for connecting to the information processing apparatus by a second communication scheme for a wireless communication that is of a higher speed than that of the first communication scheme; a connection unit configured to connect to the information processing apparatus by the second communication scheme based on the connection information obtained by the obtaining unit; and an activation unit configured to determine, in accordance with a number of jobs that the information processing apparatus holds, an application to be activated from a plurality of applications that use a communication of the second communication scheme by using information received from the information processing apparatus by a communication of the first communication scheme or the second communication scheme, and to activate the determined application.

According to still another aspect of the present invention, there is provided an information processing apparatus capable of executing a job, comprising: a first communication unit configured to establish a communication with a communication apparatus by a first communication scheme for a short-range wireless communication, and to transmit to the communication apparatus by the communication of the first communication scheme connection information for connecting to the information processing apparatus by a second communication scheme for a wireless communication that is of a higher speed than that of the first communication scheme; a second communication unit configured to, when a connection based on the connection information is accepted from the communication apparatus, establish a communication with the communication apparatus by the second communication scheme; and a transmission unit configured to transmit to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.

According to yet another aspect of the present invention, there is provided a method of controlling a communication apparatus capable of communicating with an information processing apparatus, the method comprising: connecting to the information processing apparatus by a first communication scheme for a short-range wireless communication, and obtaining from the information processing apparatus by a communication of the first communication scheme connection information for connecting to the information processing apparatus by a second communication scheme for a wireless communication that is of a higher speed than that of the first communication scheme; connecting to the information processing apparatus by the second communication scheme based on the obtained connection information; and determining, in accordance with a number of jobs that the information processing apparatus holds, an application to be activated from a plurality of applications that use a communication of the second communication scheme by using information received from the information processing apparatus by a communication of the first communication scheme or the second communication scheme, and activating the determined application.

According to still yet another aspect of the present invention, there is provided a method of controlling an information processing apparatus capable of executing a job, comprising: establishing a communication with a communication apparatus by a first communication scheme for a short-range wireless communication, and transmitting to the communication apparatus by the communication of the first communication scheme connection information for connecting to the information processing apparatus by a second communication scheme for a wireless communication that is of a higher speed than that of the first communication scheme; when a connection based on the connection information is accepted from the communication apparatus, establishing a communication with the communication apparatus by the second communication scheme; and transmitting to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.

According to yet still another aspect of the present invention, there is provided a non-transitory computer-readable storage medium storing a computer program for causing a computer to execute a method of controlling a communication apparatus capable of communicating with an information processing apparatus, the method comprising: connecting to the information processing apparatus by a first communication scheme for a short-range wireless communication, and obtaining from the information processing apparatus by a communication of the first communication scheme connection information for connecting to the information processing apparatus by a second communication scheme for a wireless communication that is of a higher speed than that of the first communication scheme; connecting to the information processing apparatus by the second communication scheme based on the obtained connection information; and determining, in accordance with a number of jobs that the information processing apparatus holds, an application to be activated from a plurality of applications that use a communication of the second communication scheme by using information received from the information processing apparatus by a communication of the first communication scheme or the second communication scheme, and activating the determined application.

According to still yet another aspect of the present invention, there is provided a non-transitory computer-readable storage medium storing a computer program for causing a computer to execute a method of controlling an information processing apparatus capable of executing a job, comprising: establishing a communication with a communication apparatus by a first communication scheme for a short-range wireless communication, and transmitting to the communication apparatus by the communication of the first communication scheme connection information for connecting to the information processing apparatus by a second communication scheme for a wireless communication that is of a higher speed than that of the first communication scheme; when a connection based on the connection information is accepted from the communication apparatus, establishing a communication with the communication apparatus by the second communication scheme; and transmitting to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.

By virtue of the present invention, it becomes possible to automatically activate an application corresponding to an operation that a user is attempting to perform in a communication apparatus when connecting to an information processing apparatus from the communication apparatus using a short-range wireless communication.

Further features of the present invention will become apparent from the following description of exemplary embodiments (with reference to the attached drawings).

### BRIEF DESCRIPTION OF THE DRAWINGS

FIG. 1 is a block diagram for illustrating an example configuration of a communication system.

FIG. 2 is a sequence diagram for showing an example of a sequence of communication between a mobile device and an image forming apparatus.

FIG. 3A and FIG. 3B are block diagrams for showing examples of hardware configurations of the mobile device and the image forming apparatus.

FIG. 4 is a flowchart for illustrating an operation procedure in the mobile device.

FIG. 5 is a view for illustrating examples of screens displayed by a print job generation application.

FIG. 6 is a view for illustrating an example of a screen displayed by a print job control application.

FIG. 7A to FIG. 7C are flowcharts for illustrating operation procedures in the image forming apparatus.

FIG. 8 is a block diagram for illustrating an example configuration of the communication system.

FIG. 9 is a block diagram for illustrating an example configuration of the communication system.

FIG. 10 is a sequence diagram for showing an example of a sequence of communication between the mobile device and the image forming apparatus.

FIG. 11 is a flowchart for illustrating an operation procedure in the mobile device.

FIG. 12 is a flowchart for illustrating a procedure of data reception processing in the image forming apparatus.

FIG. 13 is a flowchart for illustrating a procedure of data transmission processing in the image forming apparatus.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

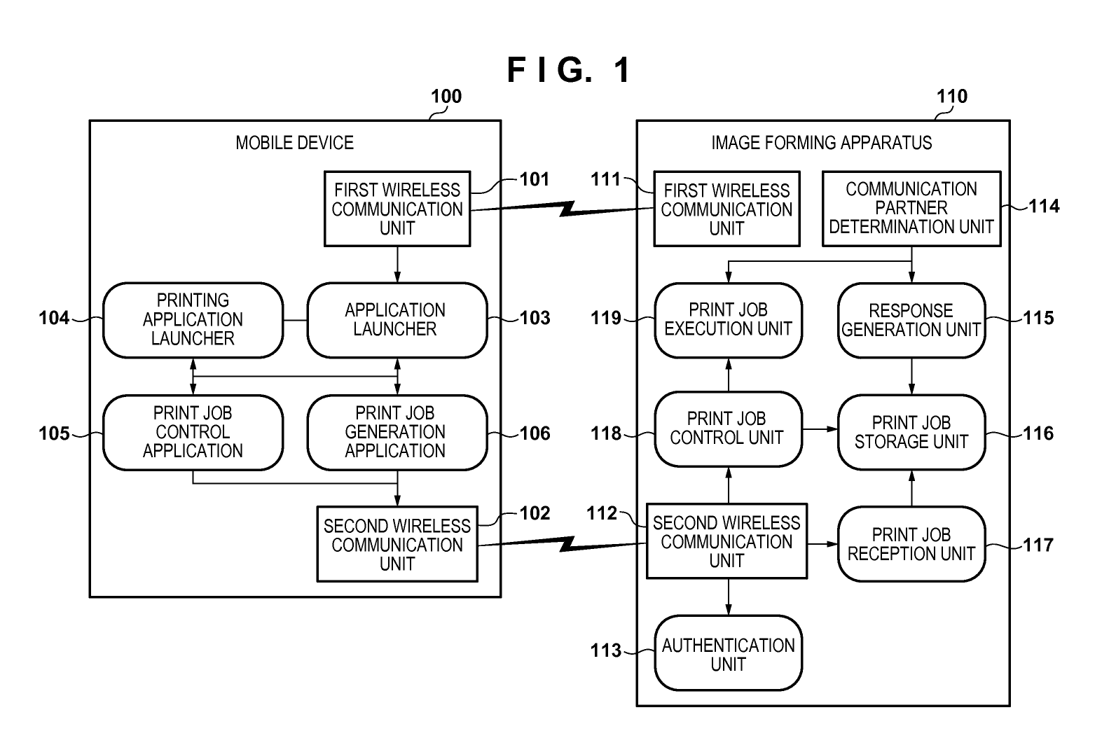

Firstly, explanation will be given for a first embodiment with reference to FIG. 1 through FIG. 8.

<Communication System Configuration>

FIG. 1 is a block diagram for illustrating an example configuration of a communication system according to the present embodiment. The communication system includes a mobile device 100 and an image forming apparatus 110. The mobile device 100 and the image forming apparatus 110 support NFC (Near Field Communication) and WiFi as communication schemes. The image forming apparatus 110 is an example of an information processing apparatus capable of executing jobs, and is capable of executing various jobs such as print jobs for printing images to recording sheets, read jobs for reading an image from an original, copy jobs for performing a copy of an original, or the like, for example. The mobile device 100 is an example of a communication apparatus capable of communicating with an information processing apparatus (the image forming apparatus 110). Also, NFC is an example of a first communication scheme for a short-range wireless communication, and WiFi is an example of a second communication scheme for a wireless communication of a higher speed than that of the first communication scheme.

(Mobile Device 100)

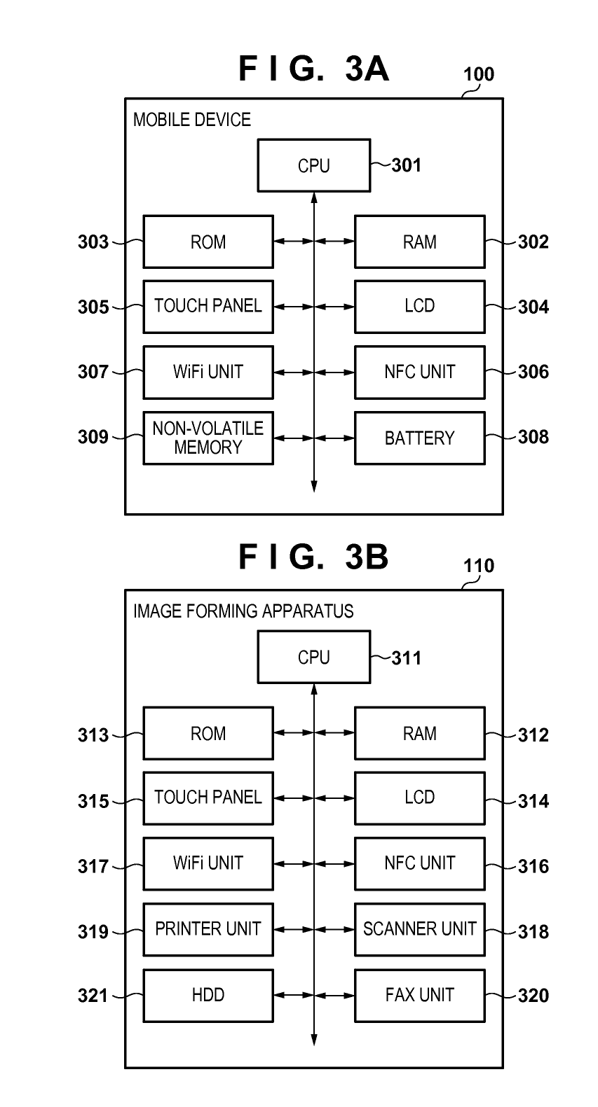

The mobile device 100 comprises a first wireless communication unit 101 and a second wireless communication unit 102. In the present embodiment, the first wireless communication unit 101 is an example of a hardware unit for performing communication (NFC communication) by NFC, which is an example of communication by the first communication scheme. The second wireless communication unit 102 is an example of a hardware unit for performing communication (WiFi communication) by WiFi, which is an example of communication by the second communication scheme. In the mobile device 100, by a CPU 301 (FIG. 3A) executing a program, an application launcher 103, a printing application launcher 104, a print job control application 105, and a print job generation application 106 operate.

The application launcher 103 activates various applications that the mobile device 100 comprises in accordance with information received by the first wireless communication unit 101, input from a user, an instruction from an application, or the like. Also, the application launcher 103 is able to transfer various parameters passed from an activation request source that requests the activation of an application to an activated application.

The printing application launcher 104 is activated by the application launcher 103. The printing application launcher 104 performs communication with the image forming apparatus 110 via the second wireless communication unit 102 to activate various applications associated with the execution of print jobs.

The print job control application 105 and the print job generation application 106 are activated by the printing application launcher 104. The print job control application 105 performs communication with the image forming apparatus 110 via the second wireless communication unit 102, and thereby performs control related to the execution of print jobs such as browsing, execution, or the like, of input print jobs. The print job generation application 106 transmits a print job to the image forming apparatus 110 via the second wireless communication unit 102.

The print job control application 105 can cause the print job generation application 106 to activate by controlling the application launcher 103. Also, the print job generation application 106 can cause the print job control application 105 to activate by controlling the application launcher 103.

In this way, in the present embodiment, the printing application launcher 104, the print job control application 105, and the print job generation application 106 are examples of a plurality of applications that use WiFi communication (communication by the second communication scheme).

(Image Forming Apparatus 110)

The image forming apparatus 110 comprises a first wireless communication unit 111 and a second wireless communication unit 112. In the present embodiment, the first wireless communication unit 111 is an example of a hardware unit for performing NFC communication, which is an example of communication by the first communication scheme. The second wireless communication unit 112 is an example of a hardware unit for performing WiFi communication, which is an example of communication by the second communication scheme. In the image forming apparatus 110, by a CPU 311 (FIG. 3B) executing a program, an authentication unit 113, a communication partner determination unit 114, a response generation unit 115, a print job storage unit 116, a print job reception unit 117, and a print job control unit 118 operate.

The authentication unit 113 performs authentication in order to identify a user when communication is performed with the mobile device 100 by the second wireless communication unit 112. The communication partner determination unit 114 determines whether a near field communication device (NFC device) that is a communication partner of the first wireless communication unit 111 is a card type device (hereinafter referred to as an “NFC card”) lacking an input/output device, or is a mobile device comprising an input/output device.

The response generation unit 115 generates a response to a request for data by NFC communication. The response generation unit 115 generates information for causing the printing application launcher 104 to activate by the application launcher 103 of the mobile device 100, information for to transfer to various printing applications activated by the printing application launcher 104, or the like, for example. The print job reception unit 117 is generated by the print job generation application 106 of the mobile device 100, and receives data transferred from the mobile device 100 using the second wireless communication unit 112.

The print job storage unit 116 stores a print job received by the print job reception unit 117 in a storage device (for example, an HDD 321 illustrated in FIG. 3B) in the image forming apparatus 110. The print job control unit 118, using the second wireless communication unit 112, communicates with the print job control application 105 of the mobile device 100, and controls the print job storage unit 116 and a print job execution unit 119. The print job control unit 118 controls obtainment of a print job stored in a storage device by the print job storage unit 116 and execution of printing based on a print job by the print job execution unit 119.

The print job execution unit 119 executes a print job stored in a storage device by the print job storage unit 116. The print job execution unit 119 performs processing for printing an image to a recording sheet in accordance with a print job.

<Communication System Operation>

In the communication system illustrated in FIG. 1, the mobile device 100 and the image forming apparatus 110 are capable of performing NFC communication and WiFi communication, and also are capable of performing a handover from NFC communication to WiFi communication. More specifically, the mobile device 100 connects to the image forming apparatus 110 by NFC when it is caused to approach the image forming apparatus 110 by a user. With this, the mobile device 100 obtains connection information (handover information) for connecting to the image forming apparatus 110 by WiFi from the image forming apparatus 110 by the NFC communication. Furthermore, the mobile device 100 is capable of performing a handover from the NFC communication to WiFi communication by connecting to the image forming apparatus 110 by WiFi based on the obtained handover information. In this way, it is possible to realize an operation towards the image forming apparatus 110 using the WiFi communication which is of a higher speed that that of the NFC communication in the mobile device 100.

In the present embodiment, automatically activating an application corresponding to an operation that a user is attempting to perform in the mobile device 100 when connecting to the image forming apparatus 110 from the mobile device 100 using the above described NFC communication is enabled. More specifically, the mobile device 100 determines an application that should be activated from a plurality of applications using the WiFi communication after the handover in accordance with the number of jobs that the image forming apparatus 110 holds, and activates the determined application. The mobile device 100 receives information for determining the application to be activated from the image forming apparatus 110 by NFC communication or WiFi communication, and by using the received information, determines the application to be activated.

For example, for the mobile device 100, there is the possibility that in a case where there number of jobs that the image forming apparatus 110 holds is 0, the user is attempting to perform an operation to newly generate a job and cause the image forming apparatus 110 to execute it. In such a case, the mobile device 100 activates the print job generation application 106. Also, there is a possibility that a user is attempting to perform an operation for displaying a list of jobs that the image forming apparatus 110 holds, and controlling execution of a job in a case where the number of jobs that the image forming apparatus 110 holds is 1 or more. In such a case, the mobile device 100 activates the print job control application 105. By such processing, it becomes possible to automatically activate an application corresponding to the operation that the user is attempting to perform in the mobile device 100. As a result, it becomes possible to improve the operability of the mobile device 100.

The mobile device 100 may determine an application to be activated in accordance with the number of jobs associated with a user of the mobile device 100 (of which the user is the owner) from the jobs that the image forming apparatus 110 holds. With this, it becomes possible to determine an application for which there is a high possibility of correspondence with the operation that the user is attempting to perform as the application to be activated. As a result, it becomes possible to further improve the operability of the mobile device 100.

Below, explanation will be given for specific operation by the communication system illustrated in FIG. 1. In the present embodiment, an example in which the mobile device 100 receives information indicating the number of jobs that the image forming apparatus 110 holds as information for determining the application to be activated from the image forming apparatus 110 by the WiFi communication is illustrated particularly.

<Communication System Communication Sequence>

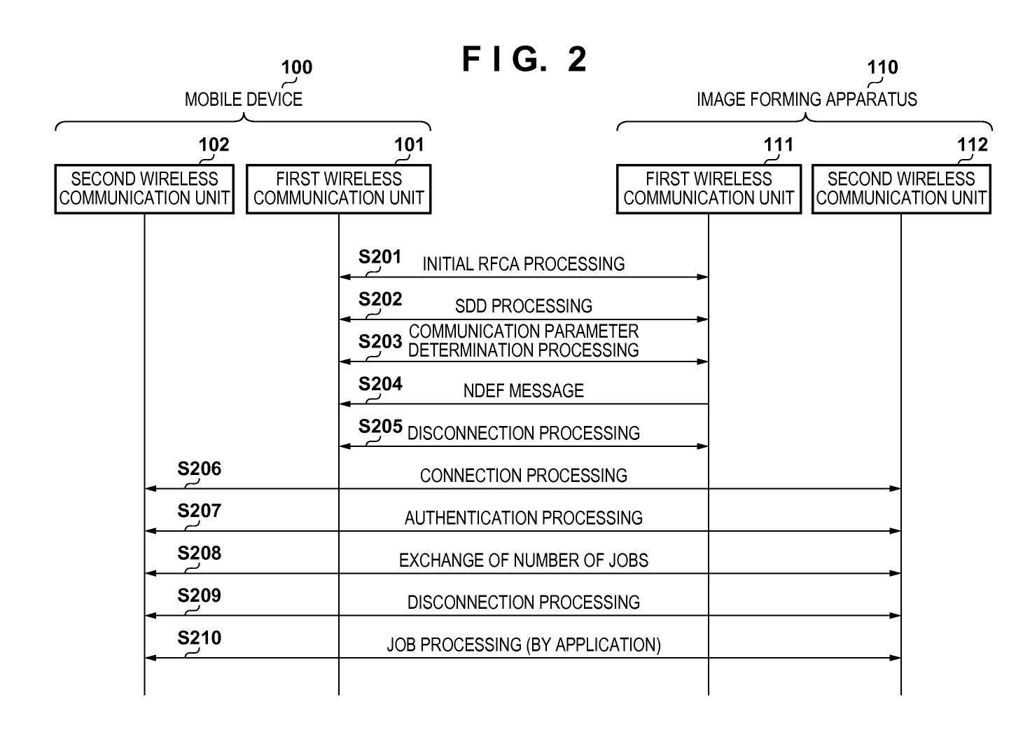

FIG. 2 is a sequence diagram for showing a sequence of communication in the communication system according to the present embodiment, and illustrates a sequence of communication between the mobile device 100 and the image forming apparatus 110. Note that step S201 to step S205 is processing using NFC communication between the first wireless communication units 101 and 111. Also, step S206 to step S210 is processing using WiFi communication between the second wireless communication units 102 and 112.

The processing of step S201 to step S203 is standardized by ISO/IEC 18092 as a protocol of a transport layer in NFC communication. Firstly, in step S201, initial RFCA (RF Collision Avoidance) processing is started in NFC communication when the first wireless communication units 101 and 111, which the mobile device 100 and the image forming apparatus 110 respectively comprise, approach within a distance at which NFC communication can be executed. Here, the initial RFCA processing indicates processing for outputting electromagnetic waves after determining whether or not the device that is an initiator can output the electromagnetic waves.

Next, in step S202, the mobile device 100 and the image forming apparatus 110 perform SDD processing to determine an identifier called an NFC ID for identifying the device that is the communication partner. Furthermore, in step S203, the mobile device 100 and the image forming apparatus 110 perform communication parameter determination processing for determining various communication parameters for performing the NFC communication.

Next, in step S204, the image forming apparatus 110 transmits to the mobile device 100 by the NFC communication an NDEF (NFC Data Exchange Format) message which is explained later and which includes information (handover information) for performance of WiFi communication between the second wireless communication units 102 and 112. Note that, the handover information is an example of connection information for connecting to the image forming apparatus 110 by WiFi. After this, in step S205, the mobile device 100 and the image forming apparatus 110 end the NFC communication between the first wireless communication units 101 and 111.

Next, in step S206, the mobile device 100, in accordance with the end of the NFC communication, performs a handover from the NFC communication to the WiFi communication by performing connection processing for the WiFi communication based on the information included in the NDEF message received in step S204. With this, the WiFi connection between the second wireless communication units 102 and 112 is established, and the WiFi communication becomes possible. When the WiFi connection is established, in step S207, the mobile device 100 and the image forming apparatus 110 perform authentication processing for identifying a user using the image forming apparatus 110 by the WiFi communication. Specifically, the mobile device 100 transmits to the image forming apparatus 110 by the WiFi communication authentication information of the user, and the image forming apparatus 110 performs user authentication based on the received authentication information.

Next, in step S208, the mobile device 100 and the image forming apparatus 110 perform an exchange of information indicating a number of print jobs of which the user who was identified by the authentication processing of step S207 is the owner by the WiFi communication. Specifically, the image forming apparatus 110 transmits to the mobile device 100 by the WiFi communication information indicating the number of print jobs associated with the authenticated user. After that, in step S209, the mobile device 100 and the image forming apparatus 110 end the WiFi communication temporarily.

Finally, in step S210, the mobile device 100, based on the information received in step S208, determines the application to be activated, and performs WiFi communication with the image forming apparatus 110 in order to operate the image forming apparatus 110 by the activated application. Here, the mobile device 100 establishes a WiFi communication with the image forming apparatus 110 once again. For example, the mobile device 100 realizes an inputting of a print job into the image forming apparatus 110 by activating the print job generation application 106. Alternatively, the mobile device 100 realizes control related to execution of the print job by realizing the print job control application 105.

<Mobile Device Hardware Configuration>

FIG. 3A is a block diagram for showing an example of a hardware configuration of the mobile device 100. The CPU 301 controls all operation of the mobile device 100 by reading out and executing various programs stored in a ROM 303 or a non-volatile memory 309. A RAM 302 is used as a temporary storage area such as a main memory for the CPU 301, a work area, or the like. In the ROM 303, various programs, management data of the mobile device 100, or the like, is stored.

An LCD 304 displays user interface images that the CPU 301 generated on the RAM 302. A touch panel 305 is a transparent sheet form sensor arranged to overlap the LCD 304, and detects operation of a user on virtual buttons, or the like, that are displayed on the LCD 304.

An NFC unit 306 performs a short-range wireless communication (a short distance wireless communication) by an electromagnetic induction in accordance with an NFC standard. A WiFi unit 307 performs a wireless communication in accordance with an IEEE 802.11 standard (wireless LAN standard). Note that the second wireless communication unit 102 corresponds to the WiFi unit 307 and the first wireless communication unit 101 corresponds to the NFC unit 306.

A battery 308 is a power supply for driving the mobile device 100. The non-volatile memory 309 is a memory for holding a record even when a power supply is not received from the battery 308. In the non-volatile memory 309, various programs, setting values registered by a user, print data, or the like, are stored.

Program corresponding to various applications (launchers) other than the first wireless communication unit 101 and the second wireless communication unit 102 illustrated in FIG. 1 are stored in the non-volatile memory 309. The various applications (launchers) illustrated in FIG. 1 operate on the CPU 301 by the CPU 301 reading programs stored in the non-volatile memory 309 into the RAM 302, and executing them as necessary.

<Image Forming Apparatus Hardware Configuration>

FIG. 3B is a block diagram for showing an example of a hardware configuration of the image forming apparatus 110. The CPU 311 controls all operation of the image forming apparatus 110 by reading out and executing various programs stored in a ROM 313 or a RAM 312. The RAM 312 is used as a temporary storage area such as a main memory for the CPU 311, a work area, or the like. In the ROM 313, various programs, management data of the image forming apparatus 110, or the like, is stored.

An LCD 314 displays user interface images that the CPU 311 generated on the RAM 312. A touch panel 315 is a transparent sheet form sensor arranged to overlap the LCD 314, and detects operation of a user on virtual buttons, or the like, that are displayed on the LCD 314.

An NFC unit 316 performs a short-range wireless communication (a short distance wireless communication) by an electromagnetic induction in accordance with an NFC standard. A WiFi unit 317 performs a wireless communication in accordance with an IEEE 802.11 standard (wireless LAN standard). Note that the second wireless communication unit 112 corresponds to the WiFi unit 317 and the first wireless communication unit 111 corresponds to the NFC unit 316.

A printer unit 319 generates image data for printing based on a print job, and prints images onto recording sheets based on the generated image data. A scanner unit 318 optically scans a paper surface, and converts an obtained electrical signal into image data. A FAX unit 320 transmits/receives facsimile data via a telephone line. In the HDD 321 various programs, setting values registered by a user, print jobs received from an external apparatus, or the like, are stored.

Program corresponding to various units other than the first wireless communication unit 111 and the second wireless communication unit 112 illustrated in FIG. 1 are stored in the ROM 313, or the like. Each unit illustrated in FIG. 1 operates on the CPU 311 by the CPU 311 reading a program stored in the ROM 313, or the like, into the RAM 312, and executing it. In this way, the units illustrated in FIG. 1 are implemented in the image forming apparatus 110 as programs that are executed by the CPU 311.

Note that the print job execution unit 119 executes print jobs by controlling the printer unit 319. Also, the print job storage unit 116 stores print data received from the mobile device 100 in the HDD 321.

<Mobile Device Operation>

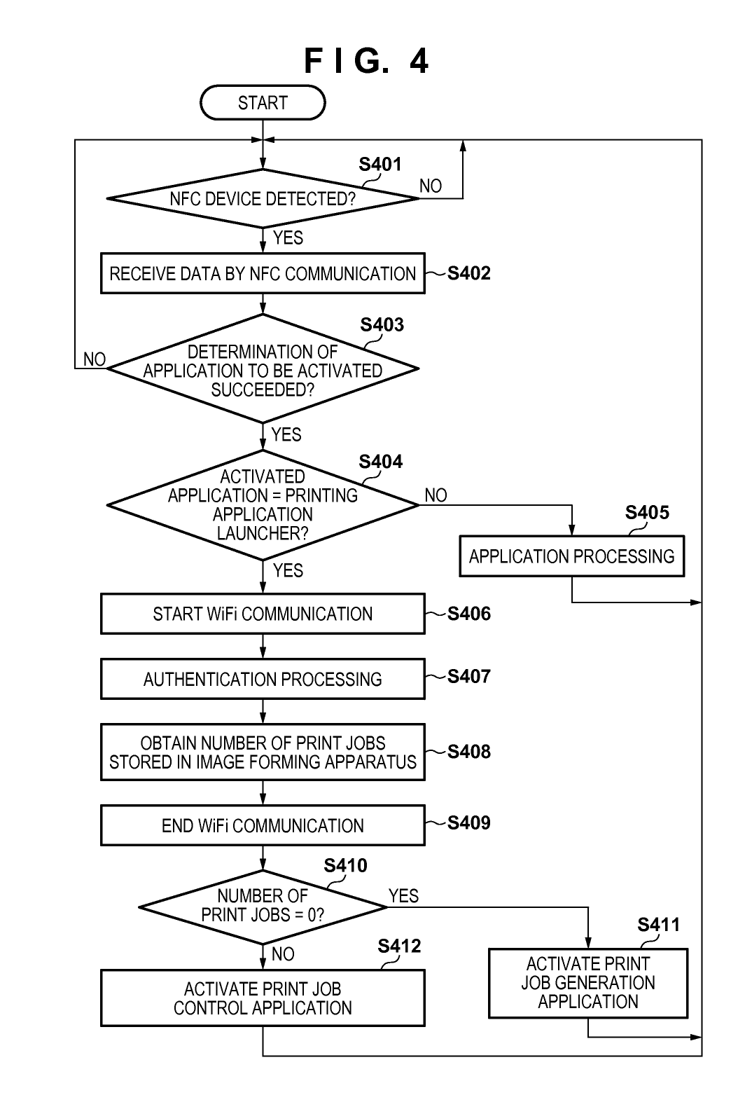

FIG. 4 is a flowchart for illustrating a procedure of processing executed by the mobile device 100 according to the present embodiment. The procedure illustrated in FIG. 4 corresponds to a procedure in which the mobile device 100 determines, and activates, an application that is necessary in order to control (operate) the image forming apparatus 110 based on information obtained by NFC communication with the image forming apparatus 110. Note that the processing of each step illustrated in FIG. 4 is realized on the mobile device 100 by the CPU 301 reading a program stored on the ROM 303 or the non-volatile memory 309 into the RAM 302 and executing it.

Firstly, in step S401, the CPU 301 controls the NFC unit 306 to attempt a connection for NFC communication, and thereby performs a detection of a near field communication device (NFC device) which is a communication device that supports NFC. Here, the NFC unit 306 operates in an “initiator mode” in the NFC communication.

In NFC communication, one device that communicate performs the communication in an “initiator mode”, and the other device performs the communication in a “target mode”. In a transport layer of NFC communication, communication is performed by a device that operates in the initiator mode (an initiator device) first performing a data request, and the device that operates in the target mode (a target device) returning a response to the request. The target device cannot perform data requests, and conversely the initiator device cannot return responses.

In step S401, the CPU 301 sets the operation mode of the NFC unit 306 to the initiator mode, and processing for determining whether or not an NFC device is detected by the NFC unit 306 is repeated until an NFC device is detected. When an NFC device is detected by the NFC unit 306, the CPU 301 advances the processing to step S402. In such a case, an NFC connection between the detected NFC device and the NFC unit 306 is performed, and the NFC communication is established. Note that the processing of step S401 corresponds to the processing of step S201 to step S203 (FIG. 2).

In step S402, the CPU 301 controls the NFC unit 306 to cause reading of information to be executed from the NFC device of the communication partner in the NFC communication. The NFC unit 306 transmits (issues) a data request command (DEP_REQ) to the NFC device of the communication partner in the NFC communication, and receives information from the NFC device by receiving a response (DEP_RES) to that request. The NFC unit 306 stores the received data in the RAM 302, and notifies the CPU 301 that the data was received.

If the NFC device to which the NFC unit 306 performed the NFC connection is the image forming apparatus 110, an NDEF message comprised in a data format called NDEF is received from the image forming apparatus 110. The NDEF message may include a plurality of NDEF records. In the present embodiment, the NDEF message transmitted from the image forming apparatus 110 to the mobile device 100 includes service information, handover information, application information, network information, and device information, as below.

service information: information representing a communication partner device.

handover information: connection information for connecting to the image forming apparatus 110 which includes a designation of a communication scheme for communication that is performed following the NFC communication.

application information: information including a designation of an application that should be activated on the mobile device 100.

network information: information including a network parameter.

device information: information regarding the image forming apparatus.

Meanwhile, when the device to which the NFC unit 306 performed the NFC connection is not the image forming apparatus 110, the information received from the device is not a message comprised in NDEF.

In either of the above described cases, the CPU 301 ends the NFC communication by controlling the NFC unit 306 and advances the processing to step S403 when a notification indicating that the data is stored in the RAM 302 is received from the NFC unit 306. Note that the processing of step S402 corresponds to the processing of step S204 to step S205 (FIG. 2).

In step S403, the CPU 301 first reads a program corresponding to the application launcher 103 from the non-volatile memory 309 into the RAM 302 and executes it. With this, the application launcher 103 enters a state in which it operates on the CPU 301. Furthermore, the CPU 301 (the application launcher 103), determines the application to be activated based on the information stored in the RAM 302 in step S402. The determination of the application is performed by describing specific data patterns in files called manifest files which are defined for each application, for example, and comparing those data patterns with the received information.

When, in step S403, the CPU 301 cannot determine the application to be activated (the determination fails), the processing by the application launcher 103 ends, and the processing returns to step S401 without executing another application. On the other hand, when the CPU 301 can determine the application to be activated (the determination succeeds), it advances the processing to step S404.

In step S404, the CPU 301 (the application launcher 103) determines whether or not the application to be activated is the printing application launcher 104. The CPU 301 advances the processing from step S404 to step S405 when the application to be activated is not the printing application launcher 104. In step S405, the CPU 301 (the application launcher 103) by reading the determined application from the non-volatile memory 309 into the RAM 302 and executing it, executes the processing according to the application. When the processing according to the application ends, the CPU 301 returns the processing to step S301.

Meanwhile, the CPU 301 advances the processing from step S404 to step S406 when the application to be activated is the printing application launcher 104. Here, in a case where the CPU 301 (the application launcher 103) activates the printing application launcher 104, the CPU 301 reads a program corresponding to the printing application launcher 104 from the non-volatile memory 309 into the RAM 302 and executes it. With this, the printing application launcher 104 enters a state in which it operates on the CPU 301.

Next, in step S406, the CPU 301 (the printing application launcher 104) starts communication with the image forming apparatus 110 based on the handover information and the network information received in step S402. More specifically, the CPU 301 (the printing application launcher 104) controls the WiFi unit 307 to start the WiFi communication with the image forming apparatus 110, and thereby performs a handover from the NFC communication to the WiFi communication. Note that the processing of step S406 corresponds to the processing of step S206 (FIG. 2).

Next, in step S407, the CPU 301 (the printing application launcher 104) performs authentication processing with the image forming apparatus 110 by WiFi communication with the image forming apparatus 110. Here, the authentication processing corresponds to processing for identifying the user using the image forming apparatus 110. The authentication processing is performed by transmitting a setting value (e.g. a user name) stored in advance in the non-volatile memory 309, for example, to the image forming apparatus 110 by the WiFi communication from the WiFi unit 307. Note that the processing of step S407 corresponds to the processing of step S207 (FIG. 2).

Next, in step S408, the CPU 301 (the printing application launcher 104) obtains from the image forming apparatus 110 by the WiFi communication information indicating the number of print jobs stored already in the image forming apparatus 110. In particular, in step S408, the number of print jobs of which the user identified by the authentication processing of step S407 is the owner is obtained. Note that the processing of step S408 corresponds to the processing of step S208 (FIG. 2).

When obtainment of the information indicating the number of print jobs completes, the CPU 301 (the printing application launcher 104), in step S409, disconnects the WiFi connection for the WiFi communication established between the WiFi units 307 and 317. With this, the WiFi communication with the image forming apparatus 110 ends. Note that the processing of step S409 corresponds to the processing of step S209 (FIG. 2).

Next, in step S410, the CPU 301 (the printing application launcher 104) determines whether or not the number of print jobs is 0. If the CPU 301 determines that the number of print jobs is 0, the CPU 301 determines that the print job generation application 106 is to be activated, and advances the processing from step S410 to step S411. On the other hand, if the CPU 301 determines that the number of print jobs is not 0 (1 or more), the CPU 301 determines that the print job control application 105 is to be activated, and advances the processing from step S410 to step S412. Note, the processing from step S410 to step S412 is included in the processing of step S210 (FIG. 2).

In step S411, the CPU 301 (the printing application launcher 104) reads a program corresponding to the print job generation application 106 from the non-volatile memory 309 into the RAM 302 and executes it. With this, the print job generation application 106 enters a state in which it operates on the CPU 301. After that, the CPU 301 returns the processing to step S401.

Meanwhile, in step S412, the CPU 301 (the printing application launcher 104) reads a program corresponding to the print job control application 105 from the non-volatile memory 309 into the RAM 302 and executes it. With this, the print job control application 105 enters a state in which it operates on the CPU 301. After that, the CPU 301 returns the processing to step S401.

<Print Job Generation Application Screen Examples>

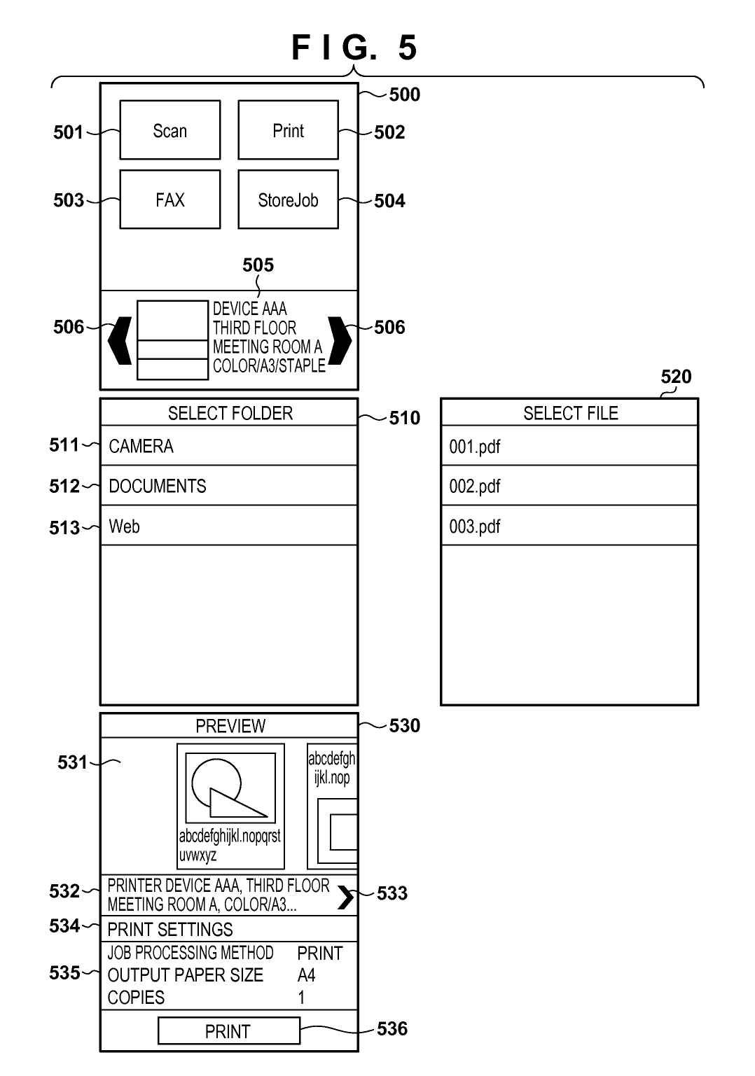

FIG. 5 is for examples of screens displayed on the LCD 304 by the print job generation application 106. The print job generation application 106 comprises at least the following functions.

a function for performing communication (WiFi communication) with the image forming apparatus 110 by the WiFi unit 307, and performing generation and transmission of print jobs.

a function for causing the image forming apparatus 110 to read an image by the scanner unit 318 and to execute a facsimile transmission by the FAX unit 320.

a function for making a request for the activation of the print job control application 105 to the application launcher 103.

In FIG. 5, a screen 500 is an activation screen of the print job generation application 106. A button 501 is used to start processing for reading an image by the scanner unit 318 of the image forming apparatus 110. A button 502 is used for starting processing for transmitting to the image forming apparatus 110 print data stored in the non-volatile memory 309. A button 503 is used to start the facsimile transmission processing by the FAX unit 320 of the image forming apparatus 110. A button 504 is used for requesting the activation of the print job control application 105.

In a region 505, information of the image forming apparatus with which communication is performed is displayed. When the print job generation application 106 is activated by the printing application launcher 104 via the NFC communication as described above, device information included in the NDEF message received in step S402 (FIG. 4) is displayed in the region 505. Buttons 506 are used to switch the image forming apparatus with which to perform communication.

The print job generation application 106 searches for an image forming apparatus that can communicate with the print job generation application 106 by a device search function such as SNMP, and is able to switch the image forming apparatus with which communication is performed in accordance with operation of the buttons 506. Basically, the image forming apparatus with which the print job generation application 106 (the mobile device 100) actually performs communication is the image forming apparatus displayed in the region 505 when the buttons 501 to 504 are pressed.

When the button 502 is pressed, the print job generation application 106 displays a screen 510 on the LCD 304. The screen 510 is a screen for selecting data to transmit to the image forming apparatus 110. A button 511 is used to select an image captured by a camera (not shown) that the mobile device 100 comprises. A button 512 is used to select print data stored in the non-volatile memory 309. A button 513 is used to select data on a network (the Web) as print data. For example, when a user presses the button 512, the print job generation application 106 displays on the LCD 304 a list of print data stored in the non-volatile memory 309, as in a screen 520, enabling the selection of the print data by the user.

When data to transmit to the image forming apparatus 110 is selected using the screen 510, the print job generation application 106 displays a screen 530 to the LCD 304. A region 531 is a region on which a preview of the selected print data is displayed. On a region 532, the information of the image forming apparatus displayed in the region 505 of the screen 500 is displayed. A button 533 is used to switch the image forming apparatus which is the transmission destination for the print data. A button 534 is used for designating various parameters used in the printing of the print data (for example, settings for a processing scheme for the job, an output sheet size, a number of print copies, or the like). In a region 535, various parameters used in the printing are displayed.

A button 536 is used for generating a print job in accordance with the selected print data and the various parameters that are set, and starting transmission of the print job to the selected image forming apparatus. In the print job transmitted in accordance with the button 536 being pressed, setting values (the user name, etc.) stored in the non-volatile memory 309, for example, are included as print job owner information.

<Print Job Control Application Screen Example>

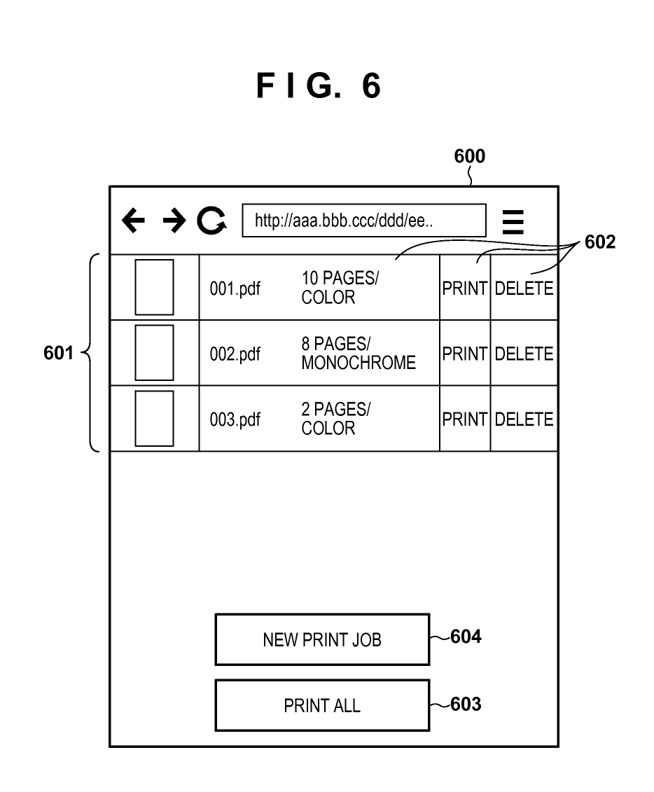

A screen 600 illustrated in FIG. 6 is an example of a screen displayed on the LCD 304 by the print job control application 105. The print job control application 105 activates by the processing of step S412 (FIG. 4), or by the button 504 being pressed. In the present embodiment, the print job control application 105 comprises a Web browser function. Specifically, the print job control application 105, in accordance with the information received in step S402, accesses a Web server operating on the image forming apparatus 110, receives HTML data, and based on the received HTML data, displays a screen on the LCD 304.

The screen 600 is an example of a screen that is based on HTML data received from the image forming apparatus 110. The screen 600 includes a list 601 of print jobs stored in the image forming apparatus 110, and includes a plurality of buttons 602 for executing or deleting the respective jobs, or changing print settings for the respective jobs. The screen 600 may include a button 603 for operating the print jobs included in the list 601 in one batch, or the like. When these buttons are pressed, the print job control application 105 transmits to the image forming apparatus 110 information corresponding to the pressed button. With this, the processing in accordance with the transmitted information is executed by the CPU 311 of the image forming apparatus 110.

Also, the screen 600 may include a button 604 for activating the print job generation application in the mobile device 100. When the button 604 is pressed, the print job control application 105 (the Web browser) controls the application launcher 103 to cause the print job generation application 106 to activate.

<Image Forming Apparatus Operation>

The NFC unit 316 of the image forming apparatus 110 according to the present embodiment can perform NFC communication not only with the mobile device 100 but also with an NFC card. When the image forming apparatus 110 performs NFC communication with the NFC card, the image forming apparatus 110 may identify a user based on information stored in the NFC card, and may execute print jobs of which the identified user is the owner from the print jobs stored in the HDD 321.

An operation mode of the NFC unit 316 must be set in accordance with a type of the NFC device which is the communication partner. More specifically, if communication is with an NFC card, the NFC unit 316 must operate in the initiator mode. On the other hand, if communication is with the mobile device 100, the NFC unit 316 must operate in the target mode. For this reason, the image forming apparatus 110 causes the NFC unit 316 to operate while causing the operation mode to switch alternatingly between the initiator mode and the target mode so as to be able to start NFC communication with an NFC card and with the mobile device 100 at any time. In this way, the NFC unit 316 attempts an NFC communication (an NFC connection) with an NFC card or the mobile device 100.

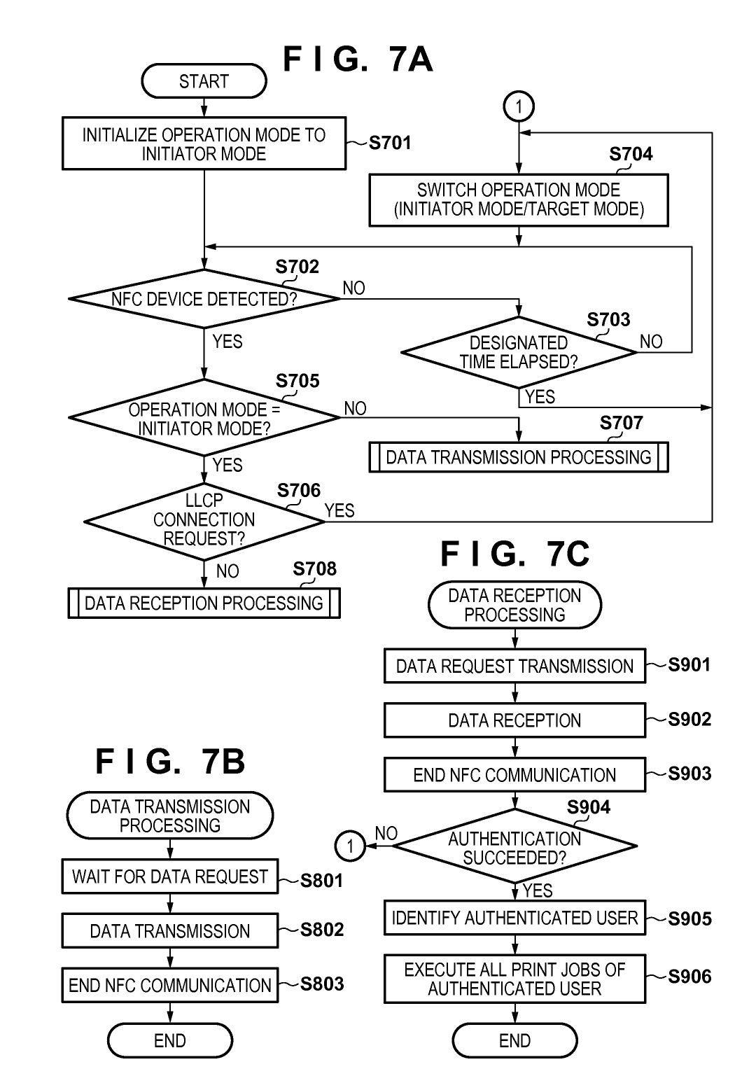

FIG. 7A to FIG. 7C are flowcharts for illustrating procedures of processing executed by the image forming apparatus 110 according to the present embodiment. In the procedure illustrated in FIG. 7A, the CPU 311 causes the NFC unit 316 to operate while switching the operation mode alternatingly between the initiator mode and the target mode. Note that the processing of each step illustrated in FIG. 7A to FIG. 7C is realized on the image forming apparatus 110 by the CPU 311 reading a program stored on the ROM 313 or the HDD 321 into the RAM 312 and executing it.

As is illustrated in FIG. 7A, the CPU 311 first initializes the NFC unit 316 to the initiator mode in step S701, and then performs detection of an NFC device in step S702. The CPU 311 determines whether or not the NFC device is detected, and if it is not detected, it further determines, in step S703, whether or not a designated time has elapsed from when the operation mode of the NFC unit 316 was initialized or switched. If the designated time has elapsed, the CPU 311, in step S704, performs switching of the operation mode of the NFC unit 316 between the initiator mode and the target mode, and repeats the detection of the NFC device in step S702. Also, if the designated time has not elapsed, the CPU 311 repeats the detection of the NFC device in step S702 without changing the operation mode of the NFC unit 316.

When, in step S702, the CPU 311 determines that an NFC device is detected, the CPU 311 advances processing to step S705. In step S705, the CPU 311 determines the operation mode of the NFC unit 316. In a case where the operation mode of the NFC unit 316 is the target mode (“NO” in step S705), the CPU 311 determines that the detected NFC device is the mobile device 100. Furthermore, the CPU 311 advances the processing to step S707, and in accordance with the procedure illustrated in FIG. 7B, causes the NFC unit 316 to execute processing for transmitting the data to the mobile device 100.

Meanwhile, in a case where the operation mode of the NFC unit 316 is the initiator mode (“YES” in step S705), the CPU 311 determines that the detected NFC device is an NFC card or the mobile device 100. Furthermore, the CPU 311 advances the processing to step S706, and determines whether or not an LLCP connection request is received. This is because the mobile device 100 side may also be attempting NFC connections by causing the NFC unit 306 to operate while switching the communication mode between the initiator mode and the target mode, similarly to the image forming apparatus 110, with the object of realizing communication with a mobile device. In a case where an NFC connection is performed between mobile devices, a protocol called the LLCP is used. If communication is performed by LLCP, a connection by LLCP is requested using a protocol of a transport layer in the NFC communication.

The image forming apparatus 110 of the present embodiment does not perform the NFC communication with the mobile device 100 by LLCP. For this reason, the CPU 311, in step S706, disconnects the NFC communication established by the detection in step S702 if it is determined to have received an LLCP connection request. After that, the CPU 311 performs switching in step S704 of the operation mode of the NFC unit 316, returns the processing to step S702, and repeats the detection of the NFC device. Meanwhile, if the CPU 311, in step S706, determines that the LLCP connection request is not received, it determines that the detected NFC device is an NFC card. Furthermore, the CPU 311 advances the processing to step S708, and in accordance with the procedure illustrated in FIG. 7C, causes the NFC unit 316 to execute data reception processing (read processing) for receiving the data from the NFC card.

(Data Transmission Processing)

FIG. 7B is a flowchart for illustrating a procedure of data transmission processing which is executed in the image forming apparatus 110. In the data transmission processing, the operation mode of the NFC unit 316 on the image forming apparatus 110 side is the target mode, and the operation mode of the NFC unit 306 on the mobile device 100 side is the initiator mode. For this reason, in the data transmission processing, the mobile device 100 transmits (issues) a data request command (DEP_REQ) to the image forming apparatus 110, and the image forming apparatus 110 transmits a response to the command (DEP_RES) to the mobile device 100.

Firstly in step S801 the CPU 311 controls the NFC unit 316 to standby until a data request command is received. When the NFC unit 316 receives a data request command it notifies the CPU 311 to that effect. The CPU 311 (the response generation unit 115), in step S802, in accordance with the notification, controls the NFC unit 316 to generate data corresponding to the above described NDEF message (step S204 of FIG. 2), and transmits it to the mobile device 100 as a response to the data request command.

After that, when the NFC unit 316 receives a communication termination command (RSL_REQ) which is transmitted from the mobile device 100, it notifies the CPU 311 to that effect. In accordance with the notification, the CPU 311, in step S803, controls the NFC unit 316 to end the NFC communication.

(Data Reception Processing)

FIG. 7C is a flowchart for illustrating an operation procedure for data reception processing (read processing) for receiving data from an NFC card which is executed in the image forming apparatus 110. In the data reception processing, the operation mode of the NFC unit 316 on the side of the image forming apparatus 110 is the initiator mode, and the operation mode of the NFC card is the target mode.

Firstly, in step S901, the CPU 311 controls the NFC unit 316 to transmit a data request command (DEP_REQ) to the NFC card. After that, the NFC unit 316, in step S902, receives a response (DEP_RES) to the data request command which is transmitted from the NFC card, and stores the received data in the RAM 312. Furthermore, the NFC unit 316 notifies the CPU 311 that data is received when the received data is stored in the RAM 312. Next, the CPU 311, in step S903, controls the NFC unit 316 to transmit a communication termination command (RSL_REQ) to the NFC card, and ends the NFC communication.

In the present embodiment, there are cases in which authentication information is included in the received data stored in the RAM 312 in step S902. The CPU 311, in step S904, performs authentication using the authentication information when the authentication information is included in the received data. In step S904, the CPU 311 returns the processing to step S704 when authentication information is not included in the received data or when the authentication using the authentication information included in the received data fails. With this, the CPU 311 switches the operation mode of the NFC unit 316 once again and repeats the detection of the NFC device. Meanwhile, the CPU 311 advances the processing to step S905 when the authentication using the authentication information included in the received data succeeds.

The CPU 311, in step S905, identifies the user of the NFC card by performing processing for converting information related to the authenticated user as necessary. This conversion processing is performed when it is necessary to convert the user authenticated using the authentication information received from the NFC card into print job owner information (information relating to the user that input the print job) stored in the image forming apparatus 110. This conversion processing is realized by holding in the image forming apparatus 110 in advance a conversion information (a table) for converting an identifier representing a user identified by the NFC card into an identifier of the user that input a print job into the image forming apparatus 110, for example.

Finally the CPU 311, in step S906, executes the print jobs that the user identified in step S905 is the owner of from the print jobs stored in the HDD 321 and ends the processing. In the HDD 321, print jobs received by the print job reception unit 117 that are transmitted from the print job generation application 106 of the mobile device 100 are stored. Because owner information is included in each print job, the CPU 311 can search for a print job including identified owner information, and execute it. Note that it may execute all jobs when a plurality of print jobs are identified.

<Image Forming Apparatus Web Server Function>

As described above, the image forming apparatus 110 comprises a Web server function, and provides HTML data for a screen display to the mobile device 100. Meanwhile, the mobile device 100 comprises a Web browser function (the print job control application 105), and receives HTML data from the image forming apparatus 110 (the Web server), and displays to the LCD 304 a screen based on the received HTML data. Below, explanation will be given of a use case of the Web server function of the image forming apparatus 110 in the present embodiment.

The image forming apparatus 110 first transmits to the mobile device 100 HTML data corresponding to an authentication information (user name and password) input screen when it receives a connection request from the print job control application 105. The print job control application 105 transmits to the image forming apparatus 110 the authentication information (the user name and the password) input by a user via the input screen based on HTML data that the mobile device 100 received from the image forming apparatus 110. With this, the authentication processing by the authentication unit 113 is performed in the image forming apparatus 110.

When the above described authentication processing completes, the image forming apparatus 110 receives information relating to a print job of which the user identified by the authentication processing by the authentication unit 113 is the owner from the print job storage unit 116, and generates HTML data corresponding to the screen 600. Furthermore, the image forming apparatus 110 transmits the generated HTML data to the mobile device 100. With this, the print job control application 105 displays the screen 600 on the LCD 304.

The print job control application 105 communicates information indicating an operation of the user to the image forming apparatus 110 (the print job control unit 118) via the screen displayed on the LCD 304. The print job control unit 118 executes processing in accordance with the operation of the user by executing processing in accordance with the received information. For example, when the execution of a print job that the user specified is instructed (when a “print” button corresponding to one of the print jobs shown on the screen 600 is pressed), the print job control unit 118 obtains the designated print job via the print job storage unit 116. The print job control unit 118 transfers the obtained print job to the print job execution unit 119, and the print job execution unit 119 executes the print job.

As explained above, in the present embodiment, the mobile device 100 determines the application to be activated in accordance with the number of the print jobs that the image forming apparatus 110 holds when the mobile device 100 performs the NFC connection to the image forming apparatus 110, and activates the determined application. With this, automatically activating an application corresponding to an operation that a user is attempting to perform in the mobile device 100 when connecting to the image forming apparatus 110 from the mobile device 100 using the above described NFC communication becomes possible. As a result, it becomes possible to improve the operability of the mobile device 100.

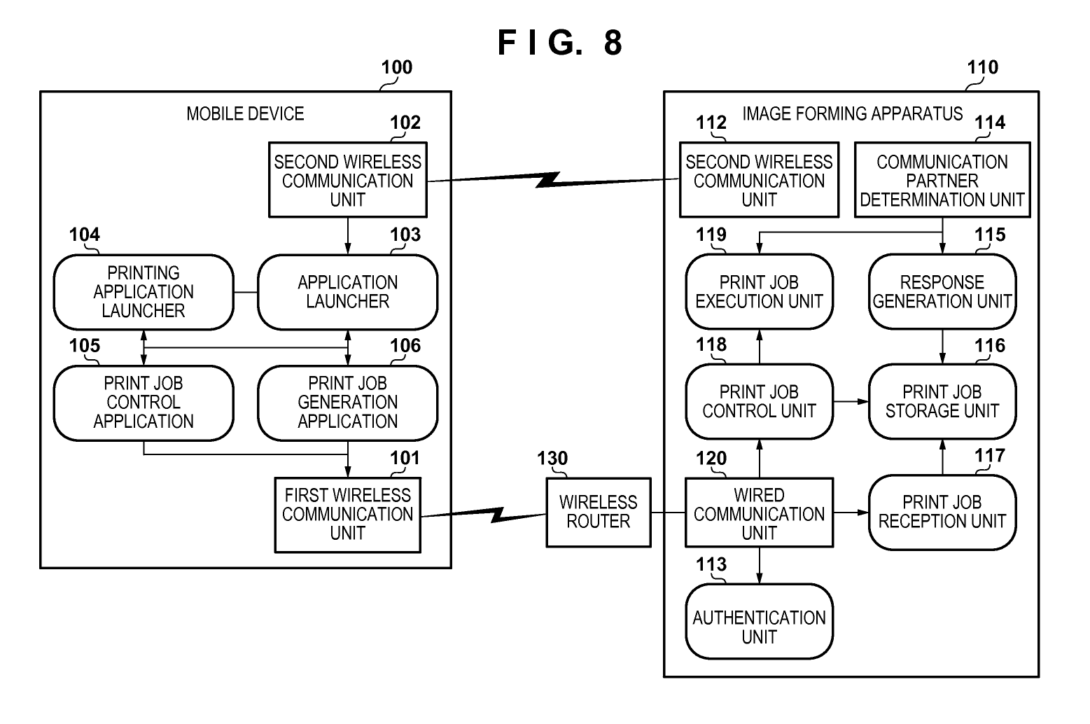

Note that various changes to the present embodiment are possible. For example, the second wireless communication unit 112 (FIG. 1) illustrated in FIG. 1 may be replaced with a wired communication unit 120 which is capable of executing wired communication, as is illustrated in FIG. 8. Furthermore, the WiFi unit 317 of FIG. 3B may be replaced with a wired LAN I/F, for example. In such a case, as is illustrated in FIG. 8, a wireless router 130 which is capable of executing communication in accordance with a wireless LAN standard (including WiFi communication) may be externally-attached to the image forming apparatus 110, and connected to the wired communication unit 120. With this, it is possible to realize the same processing as the above described embodiment.

### Second Embodiment

In the first embodiment, the mobile device 100 receives information indicating the number of jobs that the image forming apparatus 110 holds from the image forming apparatus 110 by WiFi communication, and determines the application that should be activated. In contrast to this, in the second embodiment, an example in which the image forming apparatus 110 designates the application to be activated in the mobile device 100 based on the number of the jobs held is illustrated. In the present embodiment, the mobile device 100 receives, in addition to handover information, application information indicating the designated application from the image forming apparatus 110 by NFC communication, and activates the application that the received application information indicates. Below, explanation will be given mainly for points that differ to the first embodiment. Note that the hardware configurations of the mobile device 100 and the image forming apparatus 110 are the same as in the first embodiment (FIG. 3A and FIG. 3B).

<Communication System Configuration and Operation>

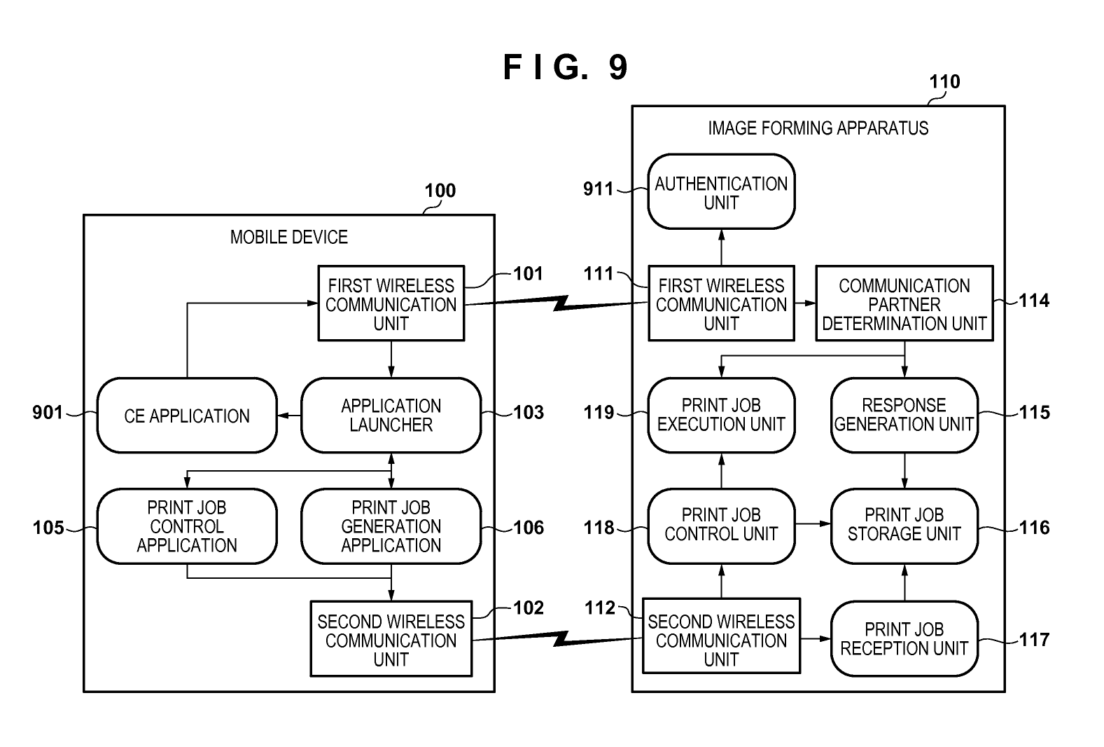

FIG. 9 is a block diagram for illustrating an example configuration of a communication system according to the present embodiment. As is illustrated in FIG. 9, the mobile device 100 differs from the first embodiment on the point that in place of the printing application launcher 104 (FIG. 1) a card emulation (CE) application 901 is provided. The CE application 901 is an application for causing the NFC unit 306 (the first wireless communication unit 111) to operate in a card emulation mode. While the CE application is activated, the NFC unit 306 operates similarly to the NFC card in the first embodiment. Also, in the present embodiment, the print job control application 105 and the print job generation application 106 are activated by the application launcher 103.

The image forming apparatus 110 differs from the first embodiment on the point that in place of the authentication unit 113 (FIG. 1) an authentication unit 911 is provided. The image forming apparatus 110 of the present embodiment performs authentication processing using an NFC communication by the first wireless communication unit 111 rather than the WiFi communication by the second wireless communication unit 112. For this reason, the authentication unit 911 is connected to the first wireless communication unit 111.

<Communication System Communication Sequence>

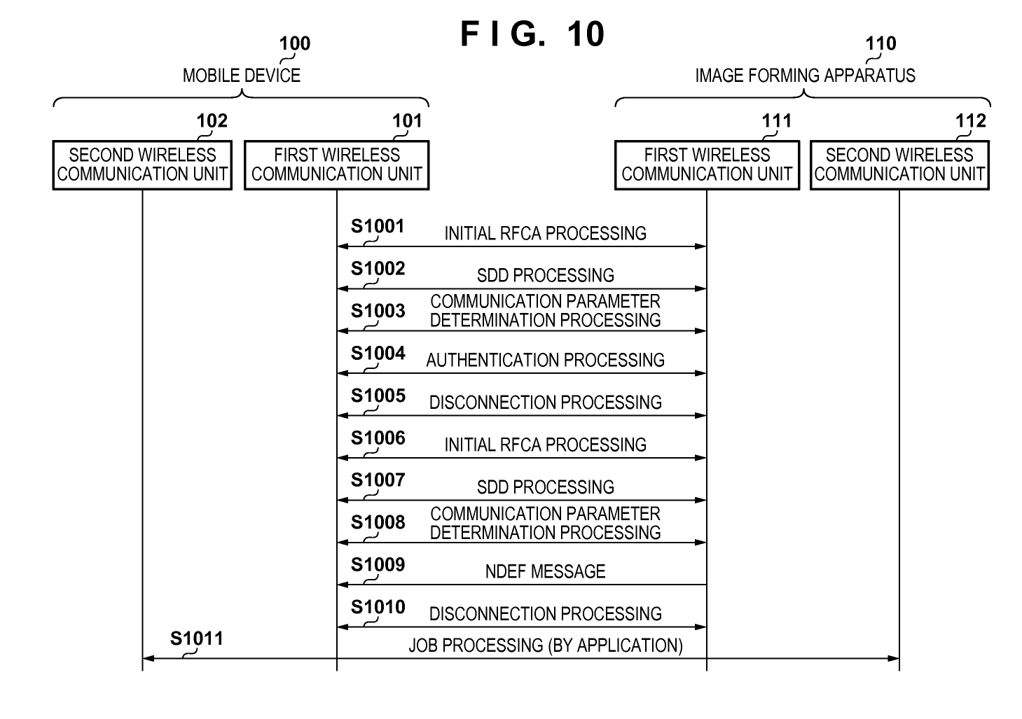

FIG. 10 is a sequence diagram for showing a sequence of communication in the communication system according to the present embodiment, and illustrates a sequence of communication between the mobile device 100 and the image forming apparatus 110. Note that step S1001 to step S1010 is processing using NFC communication between the first wireless communication units 101 and 111. Also, step S1011 is processing using WiFi communication between the second wireless communication units 102 and 112.

Firstly, the processing of step S1001 to step S1003 is the same as step S201 to step S203 in the first embodiment (FIG. 2). However, in the NFC communication established by the processing of step S1001 to step S1003 (a communication session), conversely to step S201 to step S203 the mobile device 100 operates as the target device and the image forming apparatus 110 operates as the initiator device. This is to make it possible for the mobile device 100 to transmit data (authentication information of the user) to the image forming apparatus 110 by an NFC communication.

Next, in step S1004, the mobile device 100 transmits authentication information to the image forming apparatus 110, and the image forming apparatus 110 performs authentication processing (an authentication of a user based on the received authentication information) using the authentication information received from the mobile device 100. After that, in step S1005, the mobile device 100 and the image forming apparatus 110 end the NFC communication temporarily.

Next, by the processing of step S1006 to step S1008, an NFC communication (a communication session) is once again established between the mobile device 100 and the image forming apparatus 110. Note that, the processing of step S1006 to step S1008 is the same as step S201 to step S203 in the first embodiment (FIG. 2). In the NFC communication established by the processing of step S1006 to step S1008, similarly to step S201 to step S203, the mobile device 100 operates as the initiator device, and the image forming apparatus 110 operates as the target device.

Next, in step S1009, the image forming apparatus 110 transmits to the mobile device 100 by the NFC communication an NDEF message which includes information (handover information) for performance of WiFi communication between the second wireless communication units 102 and 112. After this, in step S1010, the mobile device 100 and the image forming apparatus 110 end the NFC communication between the first wireless communication units 101 and 111.

In the present embodiment, in the NDEF message, in addition to the service information, the handover information, the application information, the network information, and the device information explained in the first embodiment, session information is included. In the present embodiment, the image forming apparatus 110 determines the application to be activated in the mobile device 100 based on the number of print jobs that the apparatus holds. Furthermore, the image forming apparatus 110 includes information indicating the determined application in the NDEF message as application information. Additionally, the application information is initialized upon activation of the image forming apparatus 110 to information indicating the print job generation application 106, for example, and upon transmission of the NDEF message, is updated based on the number of the print jobs that the image forming apparatus 110 holds.

Also, the session information is information generated upon the execution of the authentication processing in step S1004, and is information indicating a communication session corresponding to the authenticated user. By using this session information, it becomes possible to inherit the newly established communication session thereafter in a state in which the authentication of the user is complete in a communication session between the image forming apparatus 110 and the mobile device 100. Note that the generated NDEF message is saved in the RAM 312 in the image forming apparatus 110, and can be rewritten or initialized.

After this the mobile device 100, in step S1011, performs connection processing for WiFi communication based on information of handover information and session information or the like which is included in the NDEF message received in step S1009 in accordance with the end of the NFC communication. With this, the mobile device 100 performs a handover from the NFC communication to the WiFi communication. Also, the mobile device 100 determines the application that the application information included in the NDEF message received in step S1009 indicates to be the application to be activated, and activates the determined application. Furthermore, the mobile device 100 uses the WiFi communication established with the image forming apparatus 110 in order to operate the image forming apparatus 110 by the activated application.

<Mobile Device Operation>

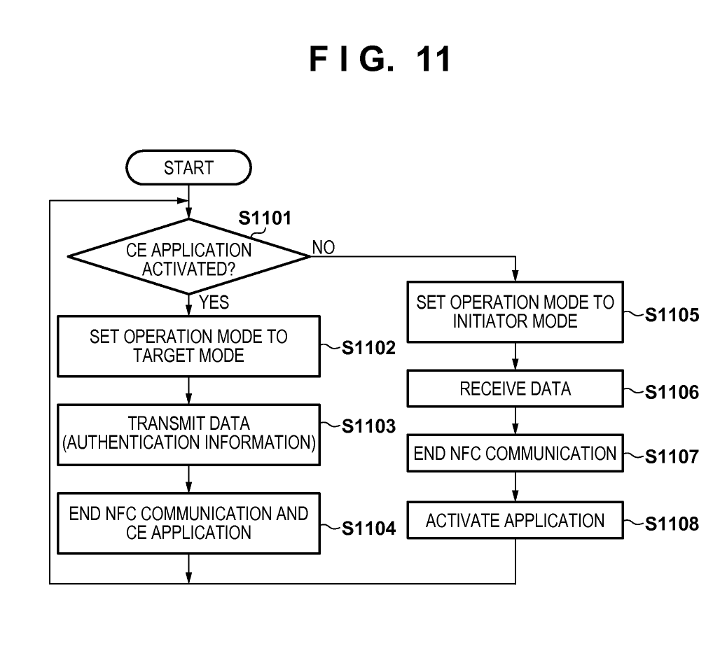

FIG. 11 is a flowchart for illustrating a procedure of processing executed by the mobile device 100 according to the present embodiment. Note that the processing of each step illustrated in FIG. 11 is realized on the mobile device 100 by the CPU 301 reading a program stored on the ROM 303 or the non-volatile memory 309 into the RAM 302 and executing it.

Firstly, in step S1101, the CPU 301 determines whether or not to activate the CE application 901. More specifically, when there is a notification from the touch panel 305 that the activation of the CE application 901 is instructed by an operation of a user, the CPU 301 determines to activate the CE application 901. In such a case, the CPU 301 reads a program corresponding to the CE application 901 from the non-volatile memory 309 into the RAM 302 and executes it. With this, the CE application 901 enters a state in which it operates on the CPU 301.

Additionally, in step S1101 the CE application 901 may be activated in accordance with reception of specific data from the image forming apparatus 110 by NFC communication, for example, rather than by an operation of a user on the touch panel 305. In such a case, the CPU 301 may set the operation mode of the NFC unit 306 to the initiator mode, and receive specific data that prompts the activation of the CE application 901 from the image forming apparatus 110.

Next, the CPU 301 (the CE application 901), in step S1102, controls the NFC unit 306 to set the operation mode of the NFC unit 306 to the target mode, and wait for the NFC communication to be started by the NFC unit 306.

The NFC unit 306 notifies the CPU 301 of the establishment of the NFC communication when an NFC communication is established. When this notification is received, the CPU 301 (the CE application 901), in step S1103, transmits the authentication information by NFC communication to the NFC device of the communication partner (the image forming apparatus 110). Thereafter, the CPU 301 (the CE application 901), in step S1104, controls the NFC unit 306 to end the NFC communication, and terminates the CE application.

Meanwhile, when the CPU 301 determines, in step S1101, to not activate the CE application 901, next in step S1105, the CPU 301 controls the NFC unit 306 to set the operation mode of the NFC unit 306 to the initiator mode, and waits for the NFC communication to be started by the NFC unit 306.

The NFC unit 306 notifies the CPU 301 of the establishment of the NFC communication when an NFC communication is established. When the notification is received, the CPU 301, in step S1106, controls the NFC unit 306 to execute reception (reading of information) of data from the NFC device of the communication partner (the image forming apparatus 110) in the NFC communication. The NFC unit 306 transmits (issues) a data request command (DEP_REQ) to the NFC device of the communication partner in the NFC communication, and receives information from the NFC device by receiving a response (DEP_RES) to that request. The NFC unit 306 stores the received data in the RAM 302, and notifies the CPU 301 that the data was received.

If the NFC device to which the NFC unit 306 performed the NFC connection is the image forming apparatus 110, an NDEF message is received from the image forming apparatus 110 in step S1106. In this NDEF message, in addition to the information included in the NDEF message received in step S204 and in step S402 in the first embodiment, the above described session information is included.

Thereafter, the CPU 301, in step S1107, controls the NFC unit 306 to end the NFC communication, reads a program corresponding to the application launcher 103 into the RAM 302 from the non-volatile memory 309 and executes it. With this, the application launcher 103 enters a state in which it operates on the CPU 301.

Next, the CPU 301 (the application launcher 103), in step S1108, determines an application that the application information included in the NDEF message received in step S1106 indicates to be the application to activate, and activates the determined application. More specifically, the CPU 301 determines the print job control application 105 or the print job generation application 106 to be the application to activate. The CPU 301 reads a program corresponding to the determined application from the non-volatile memory 309 into the RAM 302 and executes it, and thereby a state in which the determined application operates on the CPU 301 is entered.

<Image Forming Apparatus Operation>

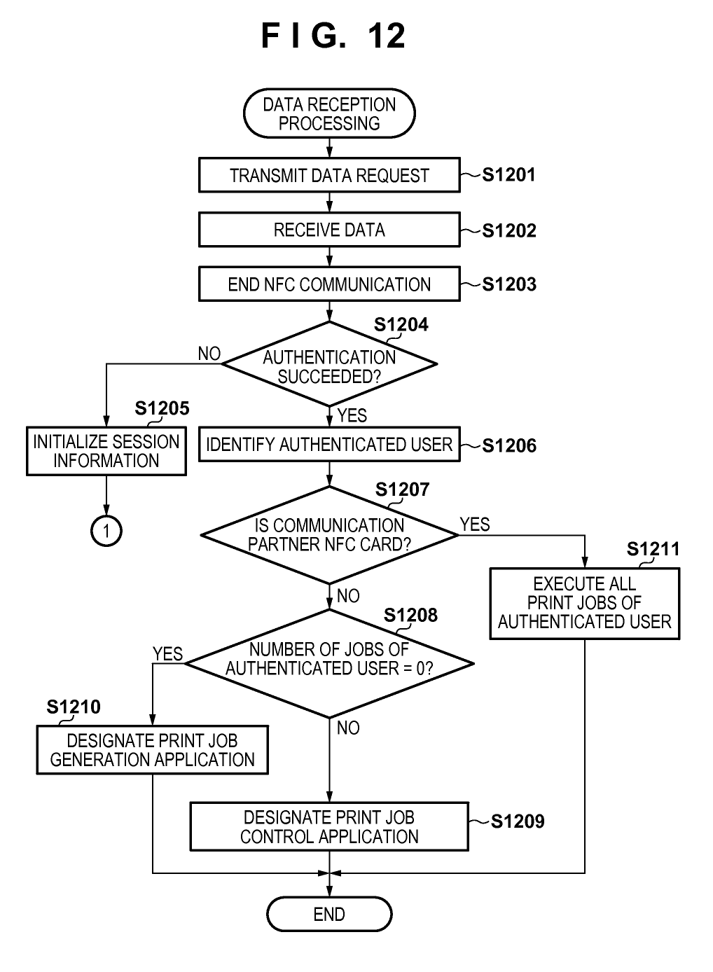

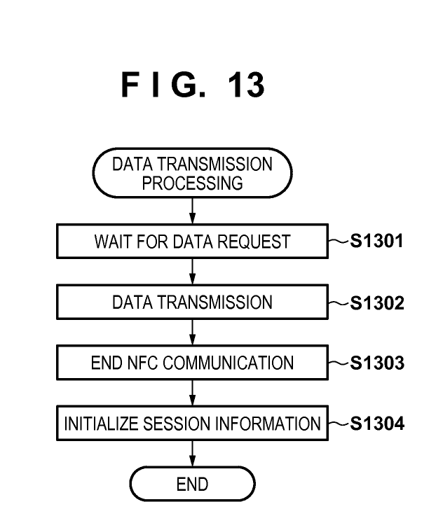

The image forming apparatus 110 operates in accordance with a procedure illustrated in FIG. 7A similarly to in the first embodiment. However, in the present embodiment, the data reception processing in step S708 is performed by the procedure illustrated in FIG. 12, and the data transmission processing in step S707 is performed by the procedure illustrated in FIG. 13.

(Data Reception Processing)

FIG. 12 is a flowchart for illustrating a procedure of data reception processing (read processing) for receiving data from a communication partner (the NFC card or the mobile device 100) which is executed in the image forming apparatus 110. In the data reception processing, the operation mode of the NFC unit 316 on the side of the image forming apparatus 110 is the initiator mode, and the operation mode of the NFC card or the NFC unit 306 of the mobile device 100 is the target mode.

Step S1201 to step S1203, other than the point that there are cases where the communication partner is the mobile device 100 rather than an NFC card, are similar to step S901 to step S903. More specifically, in step S1201, the CPU 311 controls the NFC unit 316 to transmit a data request command (DEP_REQ) to the communication partner. After that, the NFC unit 316, in step S1202, receives a response (DEP_RES) to the data request command which is transmitted from the communication partner, and stores the received data in the RAM 312. Furthermore, the NFC unit 316 notifies the CPU 311 that data is received when the received data is stored in the RAM 312. Next, the CPU 311, in step S1203, controls the NFC unit 316 to transmit a communication termination command (RSL_REQ) to the communication partner, and ends the NFC communication.

Next, the CPU 311, in step S1204, performs authentication using the authentication information when the authentication information is included in the received data. In step S1204, the CPU 311 advances the processing to step S1205 when authentication information is not included in the received data or when the authentication using the authentication information included in the received data fails. In step S1205, the CPU 311 initializes the session information included in the NDEF message which is stored in the RAM 312. With this, the session information generated by the authentication processing for the mobile device 100 being used for communication with another mobile device is prevented. After that, the CPU 311 returns the processing to step S704. Meanwhile, the CPU 311 advances the processing to step S1206 when the authentication using the authentication information included in the received data succeeds in step S1204.

The CPU 311, in step S1206, identifies the user of the NFC card by performing processing for converting information related to the authenticated user as necessary, similarly to step S905. Furthermore, the CPU 311, in step S1207, based on whether or not predetermined additional information is included in the data received in step S1202, determines whether or not the communication partner that performed the NFC connection is an NFC card (whether it is an NFC card or the mobile device 100). The CPU 311 advances the processing to step S1211 and performs processing similar to that of step S906 when it determines that the communication partner is an NFC card. Specifically the CPU 311 executes the print jobs of which the user identified in step S1206 is the owner from the print jobs stored in the HDD 321 and ends the processing.

Note that configuration may be taken such that in step S1211, in place of executing the print jobs stored in the HDD 321, a list of print jobs associated with the authenticated user is displayed on the LCD 314, such that the user can select the print job that should be executed.

Meanwhile, the CPU 311 advances the processing to step S1208 when it is determined, in step S1207, that the communication partner is not an NFC card (that it is the mobile device 100). In step S1208, the CPU 311 determines whether or not the number of print jobs of which the user identified in step S1206 is the owner from the print jobs stored in the HDD 321 is 0. The CPU 311 designates the print job generation application 106 in step S1210 as the application to be activated in the mobile device 100 when the number of the print jobs is 0. On the other hand, the CPU 311 designates the print job control application 105 in step S1209 as the application to be activated in the mobile device 100 when the number of the print jobs is not 0 (1 or more).

The information indicating the application designated in step S1209 or in step S1210 is included in an NDEF message stored in the RAM 312 as application information. With this, the transmission of the application information to the mobile device 100 is enabled in step S1302 (FIG. 13), and the activation of the application in accordance with the application information in the mobile device 100 is enabled. After that, the CPU 311 ends the processing.

(Data Transmission Processing)

FIG. 13 is a flowchart for illustrating a procedure of device communication processing which is executed in the image forming apparatus 110. The processing of step S1301 to step S1303 illustrated in FIG. 13 is the same as step S801 to step S803 (FIG. 7B) in the first embodiment. However, in the NDEF message transmitted in step S1302, as described above, session information and application information based on the number of the print jobs that the image forming apparatus 110 holds are included. In the present embodiment, after the end of the NFC communication in step S1303, the CPU 311, in step S1304, initializes the session information. With this, the session information generated by the authentication processing for the mobile device 100 being used for communication with another mobile device is prevented.

As explained above, in the present embodiment, the image forming apparatus 110 determines the application to be activated in the mobile device 100 based on the number of print jobs held when the image forming apparatus 110 accepts the NFC connection from the mobile device 100. The mobile device 100 activates an application in accordance with the application information received as the NDEF message when the NFC connection to the image forming apparatus 110 is performed. With this, similarly to the first embodiment, automatically activating an application corresponding to an operation that a user is attempting to perform in the mobile device 100 when connecting to the image forming apparatus 110 from the mobile device 100 using the above described NFC communication is enabled.

Also, it becomes possible to use the session information generated in the authentication processing performed by NFC communication in the WiFi communication performed thereafter. With this, it becomes possible to perform operation of the image forming apparatus 110 safely and easily using the activated application in the mobile device 100.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-224615, filed Nov. 4, 2014, which is hereby incorporated by reference herein in its entirety.

What is claimed is:

1. A communication system comprising an information processing apparatus capable of executing a job, and a communication apparatus capable of communicating with the information processing apparatus, wherein
the information processing apparatus comprises:
a first communication unit configured to perform a communication of a first communication scheme for a short-range wireless communication; and
a second communication unit configured to perform a communication of a second communication scheme for a wireless communication that is of a higher speed than that of the first communication scheme, and wherein
the communication apparatus comprises:
an obtaining unit configured to connect to the information processing apparatus by the first communication scheme, and to obtain from the information processing apparatus by the communication of the first communication scheme connection information for connecting to the information processing apparatus by the second communication scheme;
a connection unit configured to connect to the information processing apparatus by the second communication scheme based on the connection information obtained by the obtaining unit; and
an activation unit configured to determine, in accordance with a number of jobs that the information processing apparatus holds, an application to be activated from a plurality of applications that use the communication of the second communication scheme by using information received from the information processing apparatus by communication of the first communication scheme or the second communication scheme, and to activate the determined application.

2. The communication system according to claim 1, wherein the activation unit determines the application to be activated in accordance with the number of jobs associated with a user of the communication apparatus from jobs that the information processing apparatus holds.

3. The communication system according to claim 1, wherein
the information processing apparatus further comprises a first transmitting unit configured to transmit information indicating the number of jobs that the information processing apparatus holds by the communication of the second communication scheme, and wherein
the activation unit determines the application to be activated in accordance with the number of jobs indicated by the information received from the information processing apparatus by the communication of the second communication scheme.

4. The communication system according to claim 3, wherein
the communication apparatus further comprises a second transmitting unit configured to transmit to the information processing apparatus by the communication of the second communication scheme authentication information of a user, and wherein
the information processing apparatus further comprises an authentication unit configured to perform an authentication of a user based on the authentication information received by the communication of the second communication scheme from the communication apparatus, and wherein
the first transmitting unit transmits to the communication apparatus by the communication of the second communication scheme information indicating the number of jobs associated with the user authenticated by the authentication unit.

5. The communication system according to claim 3, wherein
the obtaining unit ends the communication of the first communication scheme when the connection information is obtained from the information processing apparatus, and wherein
the connection unit performs a handover to the communication of the second communication scheme from the communication of the first communication scheme by connecting to the information processing apparatus by the second communication scheme based on the connection information, in accordance with the end of the communication of the first communication scheme.

6. The communication system according to claim 1, wherein
the information processing apparatus further comprises:
a determination unit configured to determine the application to be activated in the communication apparatus from the plurality of applications based on the number of jobs that the information processing apparatus holds; and
a first transmitting unit configured to transmit to the communication apparatus by the communication of the first communication scheme application information indicating the application determined by the determination unit together with the connection information, and wherein
the activation unit activates the application that the application information, which is obtained by the obtaining unit with the connection information, indicates.

7. The communication system according to claim 6, wherein
the communication apparatus further comprises a second transmitting unit configured to transmit to the information processing apparatus by the communication of the first communication scheme authentication information of a user, and wherein
the information processing apparatus further comprises an authentication unit configured to perform an authentication of a user based on the authentication information received by the communication of the first communication scheme from the communication apparatus, and wherein
the determination unit determines, based on a number of jobs associated with the user authenticated by the authentication unit, the application to be activated in the communication apparatus from the plurality of applications.

8. The communication system according to claim 7, wherein
the first transmitting unit transmits to the communication apparatus by the communication of the first communication scheme session information indicating a communication session corresponding to the user authenticated by the authentication unit together with the application information and the connection information, and wherein
the connection unit, based on the session information and the connection information obtained by the obtaining unit, connects to the information processing apparatus by the second communication scheme.

9. The communication system according to claim 8, wherein
the obtaining unit, when the connection information, the application information, and the session information are obtained from the information processing apparatus, ends the communication of the first communication scheme, and wherein
the connection unit performs a handover to the communication of the second communication scheme from the communication of the first communication scheme by connecting to the information processing apparatus by the second communication scheme based on the connection information and the session information, in accordance with the end of the communication of the first communication scheme.

10. The communication system according to claim 1, wherein
the activation unit
activates a first application for generating a job that causes the information processing apparatus to execute in a case where a number of jobs that the information processing apparatus holds is 0, and
activates a second application for displaying a list of jobs that the information processing apparatus holds, and controlling an execution of a job in a case where the number of jobs that the information processing apparatus holds is 1 or more.

11. A communication apparatus capable of communicating with an information processing apparatus, the communication apparatus comprising:
an obtaining unit configured to connect to the information processing apparatus by a first communication scheme for a short-range wireless communication, and to obtain from the information processing apparatus by a communication of the first communication scheme connection information for connecting to the information processing apparatus by a second communication scheme for a wireless communication that is of a higher speed than that of the first communication scheme;
a connection unit configured to connect to the information processing apparatus by the second communication scheme based on the connection information obtained by the obtaining unit; and
an activation unit configured to determine, in accordance with a number of jobs that the information processing apparatus holds, an application to be activated from a plurality of applications that use a communication of the second communication scheme by using information received from the information processing apparatus by a communication of the first communication scheme or the second communication scheme, and to activate the determined application.

12. An information processing apparatus capable of executing a job, comprising:
a first communication unit configured to establish a communication with a communication apparatus by a first communication scheme for a short-range wireless communication, and to transmit to the communication apparatus by the communication of the first communication scheme connection information for connecting to the information processing apparatus by a second communication scheme for a wireless communication that is of a higher speed than that of the first communication scheme;
a second communication unit configured to, when a connection based on the connection information is accepted from the communication apparatus, establish a communication with the communication apparatus by the second communication scheme; and
a transmission unit configured to transmit to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.

13. A method of controlling a communication apparatus capable of communicating with an information processing apparatus, the method comprising:
connecting to the information processing apparatus by a first communication scheme for a short-range wireless communication, and obtaining from the information processing apparatus by a communication of the first communication scheme connection information for connecting to the information processing apparatus by a second communication scheme for a wireless communication that is of a higher speed than that of the first communication scheme;
connecting to the information processing apparatus by the second communication scheme based on the obtained connection information; and
determining, in accordance with a number of jobs that the information processing apparatus holds, an application to be activated from a plurality of applications that use a communication of the second communication scheme by using information received from the information processing apparatus by a communication of the first communication scheme or the second communication scheme, and activating the determined application.

14. A method of controlling an information processing apparatus capable of executing a job, comprising:
establishing a communication with a communication apparatus by a first communication scheme for a short-range wireless communication, and transmitting to the communication apparatus by the communication of the first communication scheme connection information for connecting to the information processing apparatus by a second communication scheme for a wireless communication that is of a higher speed than that of the first communication scheme;
when a connection based on the connection information is accepted from the communication apparatus, establishing a communication with the communication apparatus by the second communication scheme; and
transmitting to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.

15. A non-transitory computer-readable storage medium storing a computer program for causing a computer to execute a method of controlling a communication apparatus capable of communicating with an information processing apparatus, the method comprising:
connecting to the information processing apparatus by a first communication scheme for a short-range wireless communication, and obtaining from the information processing apparatus by a communication of the first communication scheme connection information for connecting to the information processing apparatus by a second communication scheme for a wireless communication that is of a higher speed than that of the first communication scheme;
connecting to the information processing apparatus by the second communication scheme based on the obtained connection information; and
determining, in accordance with a number of jobs that the information processing apparatus holds, an application to be activated from a plurality of applications that use a communication of the second communication scheme by using information received from the information processing apparatus by a communication of the first communication scheme or the second communication scheme, and activating the determined application.

16. A non-transitory computer-readable storage medium storing a computer program for causing a computer to execute a method of controlling an information processing apparatus capable of executing a job, comprising:
establishing a communication with a communication apparatus by a first communication scheme for a short-range wireless communication, and transmitting to the communication apparatus by the communication of the first communication scheme connection information for connecting to the information processing apparatus by a second communication scheme for a wireless communication that is of a higher speed than that of the first communication scheme;
when a connection based on the connection information is accepted from the communication apparatus, establishing a communication with the communication apparatus by the second communication scheme; and
transmitting to the communication apparatus by a communication of the first communication scheme or the second communication scheme information for determining, in accordance with a number of jobs that the information processing apparatus holds, an application to be activated on the communication apparatus from a plurality of applications that use a communication of the second communication scheme.
